(19) United States
(12) Patent Application Publication
(10) Pub. No.: US 2002/0028738 A1
(43) Pub. Date: Mar. 7, 2002

(54) Twist-It

(76) Inventor: Lary Harmon, Solana Beach, CA (US)

Correspondence Address: LARRY HARMON, 4806 West Ave. M-14, QUARTZ HILL, CA, 93536, US

(21) Appl. No.: 09/737,022

(22) Filed: Dec. 13, 2000

Related U.S. Application Data
(60) Provisional application No. 60/170,722, filed on Dec. 15, 1999.

(51) Int. Cl. B31F 1/10

(52) U.S. Cl. 493/442

(57) ABSTRACT

“Twist-It”, is a tee shaped cranking tool with a slip grip, used to twist one or two rolls of crepe paper streamers.(crepe streamers as used in decorating for parties or events) With paper roll or rolls mounted to the tee and with a cranking motion, it will twist, or twist and intertwine both rolls of crepe streamers.

### BACK ROUND OF INVENTION

1. Field of Invention

This invention relates to devices used to, twist paper rolls. Or intertwine them, The new device provides a simple means for the user to twist a paper roll or twist and intertwine two paper rolls, as in cindus streamer paper rolls used in decorating for a party or event.

2. Description of Related Art

The current way of twisting paper rolls, is by a hand over hand procedure, to twist and intertwine two paper rolls, is also done by a hand over hand operation. The presented invention provides user to twist and or intertwine paper rolls.

### SUMMARY OF THE INVENTION

The objective of the presented invention is to enable the user to twist one paper roll or twist and intertwine two paper rolls at the same time, by the means of cranking and walking. Other objective will become apparent when description and drawings are reviewed.

### BRIEF DESCRIPTION OF DRAWINGS

FIG. 1 Illustrates perspective side view of Twist-It with hand griping positions, placement of paper rolls and slip grip collar.

FIG. 2 Illustrates end view and position of slip grip collar.

FIG. 3 Illustrates side view of, plastic spindles.

FIG. 4 Illustrates side view of plastic Tee.

FIG. 5 Illustrates side view of plastic molded crank handle.

FIG. 6 Illustrates side view of plastic slip grip collar.

FIG. 7 Illustrates view of Twist-It as a one piece Tee and crank, with a snap together slip grip collar.

FIG. 8 Illustrates Hairpin used to keep paper rolls in place, Hairpin not part of patent request, for illustration only.

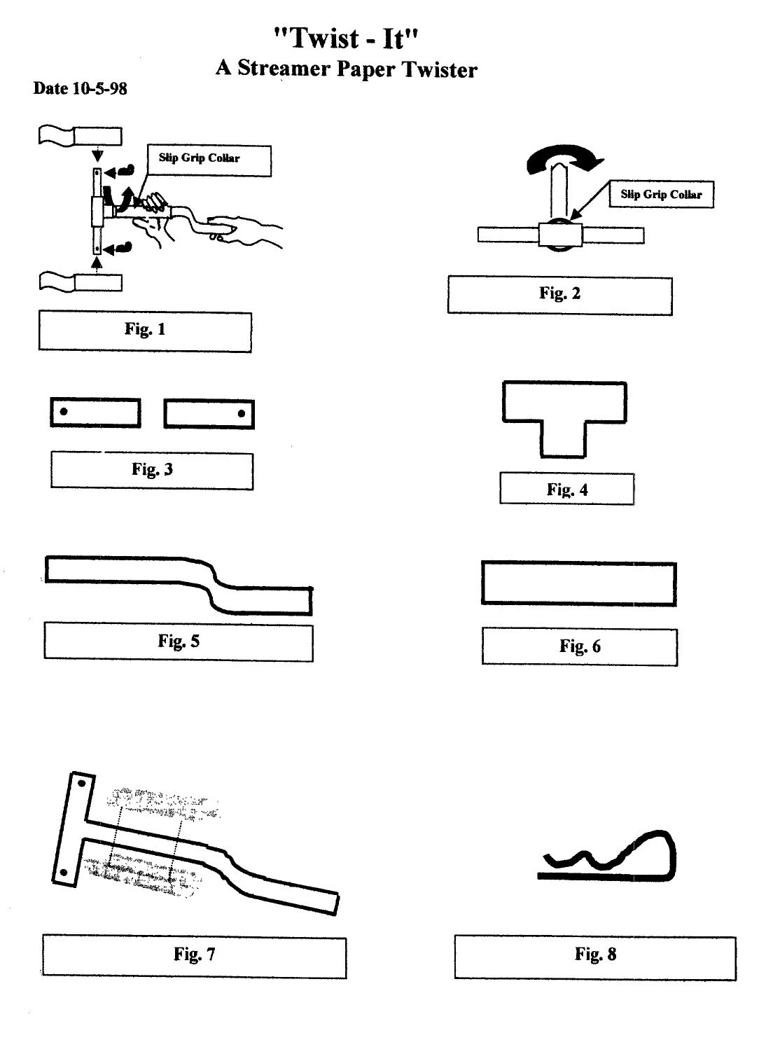

### DESCRIPTION OF THE PREFERRED EMBODIMENT

The Twist-It consist of a crank handle (FIG. 5), slip grip collar (FIG. 6), Tee (FIG. 4) and Spindles (FIG. 3). Twist-It is made of plastic. Crank Handle and spindles are a glued slip fit into Tee. Twist-It FIG. 7 would be a plastic Tee and Crank Handle made of one piece, with a snap together Slip Grip Collar.

1. A device for twisting paper rolls.

2. The device as in claim one, enables user to twist and or twist and intertwine paper rolls with a minimum effort.

3. As in claim one twist It has a slip grip collar which slips over crank handle.

4. The device as in claim one is made of plastic and of three pieces, one being the crank handle and Tee molded into one, the other two being the two half's of the slip grip collar, the two half's of the slip grip collar would snap together around crank handle.
